(19) United States
(12) Patent Application Publication
(10) Pub. No.: US 2026/0099877 A1
(43) Pub. Date: Apr. 9, 2026

(54) METHOD AND SYSTEM FOR AUTOMATED CREDIT DATA FURNISHING INCLUDING COMPLIANCE CHECKS AND DISPUT AUTOMATION

(71) Applicant: JPMorgan Chase Bank, N.A., New York, NY (US)

(72) Inventors: Sarathi JAYARAMAN, Wilmington, DE (US); John LANDSBOROUGH, Middletown, DE (US); Sara KNOX-ZHANG, Columbus, OH (US); Dharani MANJUNATH, Camas, WA (US); Betty DAVIS, North East, MD (US)

(73) Assignee: JPMorgan Chase Bank, N.A., New York, NY (US)

(21) Appl. No.: 18/909,650

(22) Filed: Oct. 8, 2024

(51) Int. Cl. G06Q 40/03; G06Q 10/10

(52) U.S. Cl. CPC G06Q 40/03; G06Q 10/10

(57) ABSTRACT

A method and a system for generating a file that is suitable for submission to a first credit reporting agency are provided. The method includes: receiving a first set of data that relates to a consumer; generating a consumer credit report file by using the first set of data; analyzing the consumer credit report file to determine whether the consumer credit report file violates at least one rule from among a series of rules; determining, based on a result of the analyzing of the consumer credit report file, whether the consumer credit report file is compliant with applicable governmental regulations; when a determination is made that the consumer credit report file is not compliant with the applicable governmental regulations, modifying the consumer credit report file such that, as modified, the consumer credit report file is fully compliant with all of the applicable governmental regulations.

### BACKGROUND

### 1. Field of the Disclosure

This disclosure generally relates to methods and systems for generating a file that is suitable for submission to a credit reporting agency, and more particularly to methods and systems for automatically generating a credit report file that satisfies all applicable governmental regulations prior to transmitting the file to a credit reporting agency while ensuring that the generated credit report is accurate and error free.

### 2. Background Information

Financial institutions are required by the Fair Credit Reporting Act (FCRA) and the Consumer Data Industry Association (CDIA) to provide a variety of information regarding their customers to each of the major credit reporting agencies (e.g., Experian, Equifax, Transunion, and Innovis). The credit reporting agencies require that the consumer information be transmitted in a standardized format. For large financial institutions, this is a large amount of information and data that must be formatted to comply with credit reporting agencies standards and governmental regulations.

If the credit reporting agencies identify an error or issue in the consumer information and/or formatting, they may flag the consumer information and send it back to financial institutions for correction. The financial institution is then required to fix the information and send it back to the credit reporting agencies. This process is extremely tedious and time consuming for both the financial institutions and the credit reporting agencies.

Accordingly, there is a need for systems and methods that are designed to accurately generate a credit report file that satisfies all applicable governmental regulations prior to transmitting the file to a credit reporting agency.

### SUMMARY

The present disclosure, through one or more of its various aspects, embodiments, and/or specific features or sub-components, provides, inter alia, various systems, servers, devices, methods, media, programs, and platforms for accurately generating a credit report file that satisfies all applicable governmental regulations prior to transmitting the file to a credit reporting agency while ensuring that the generated credit report is accurate and error free. According to an aspect of the present disclosure, a method for generating a file that is suitable for submission to a first credit reporting agency is provided. The method may be implemented by at least one processor. The method may include: receiving, by the at least one processor, a first set of data that relates to a consumer; generating, by the at least one processor, a consumer credit report file by using the first set of data; analyzing, by the at least one processor, the consumer credit report file to determine whether the consumer credit report file violates at least one rule from among a series of rules, wherein the series of rules includes at least one first tier rule that relates to invalid values that are not includible in the consumer credit report file and at least one second tier rule that relates to illogical values that are updatable in order to become includible in the consumer credit report file; determining, by the at least one processor based on a result of the analyzing of the consumer credit report file, whether the consumer credit report file is compliant with applicable governmental regulations; when a determination is made that the consumer credit report file is not compliant with at least one from among the applicable governmental regulations, modifying, by the at least one processor, the consumer credit report file such that, as modified, the consumer credit report file is fully compliant with all of the applicable governmental regulations; transmitting, by the at least one processor, the consumer credit report file to the first credit reporting agency; and determining, by the at least one processor based on a result of the analyzing and the modifying, a file health check score for the consumer credit report file.

The consumer credit report file may be automatically modifiable so as to ensure that the consumer credit report file does not violate the at least one second tier rule.

The method may further include when the consumer credit report file violates the at least one first tier rule, prompting, by the at least one processor, a user to provide an input that is usable for replacing at least one invalid value that is not includible in the consumer credit report file.

The method may further include receiving, by the at least one processor, a dispute inquiry that relates to the first set of data; analyzing, by the at least one processor, the consumer credit report file and the dispute inquiry to determine an accuracy of the first set of data; and when a determination is made that the first set of data includes at least one inaccurate data item, modifying, by the at least one processor, the at least one inaccurate data item in order to resolve the dispute inquiry.

The method may further include generating, based on the modifying of the at least one inaccurate data item, a response to the dispute inquiry; and transmitting, by the at least one processor to at least one predetermined entity, a notification of the response to the dispute inquiry.

The dispute inquiry may include at least one from among a first inquiry that relates to a discrepancy in a transaction payment history and a second inquiry that relates to incorrect information included in a credit report.

The modifying of the consumer credit report file may include inputting the consumer credit report file to an artificial intelligence (AI) model that is trained to perform the modifying based on historical violations of the series of rules.

The determining of the health check score may include: assessing each respective field included in the consumer credit report file to determine whether the respective field is a key field; assigning, to each respective field included in the consumer credit report file, a respective weight; evaluating each respective field to determine a respective percentage value that indicates an adherence to a corresponding standard; for each respective field, combining the respective weight with the respective percentage value to determine a respective field-specific health check score; and calculating the file health check score based on a combination of the field-specific health check scores for all fields included in the consumer credit report file.

The method may further include when a particular field is determined as being a key field, the respective weight for a value that corresponds to a first tier rule may be equal to one from among 1.0, 1.25, 1.5, 1.75, and 2.0, and the respective weight for a value that corresponds to a second tier rule may be equal to 0.75; and when the particular field is determined as not being a key field, the respective weight for the value that corresponds to the first tier rule may be equal to 1.0, and the respective weight for the value that corresponds to the second tier rule may be equal to 0.50.

According to another aspect of the present disclosure, a computing apparatus for generating a file that is suitable for submission to a first credit reporting agency is provided. The computing apparatus may include a processor; a memory; and a communication interface coupled to each of the processor, and the memory. The processor may be configured to: receive, via the communication interface, a first set of data that relates to a consumer; generate a consumer credit report file by using the first set of data; analyze the consumer credit report file to determine whether the consumer credit report file violates at least one rule from among a series of rules, wherein the series of rules includes at least one first tier rule that relates to invalid values that are not includible in the consumer credit report file and at least one second tier rule that relates to illogical values that are updatable in order to become includible in the consumer credit report file; determine, based on a result of the analysis of the consumer credit report file, whether the consumer credit report file is compliant with applicable governmental regulations; when a determination is made that the consumer credit report file is not compliant with at least one from among the applicable governmental regulations, modify the consumer credit report file such that, as modified, the consumer credit report file is fully compliant with all of the applicable governmental regulations; transmit, via the communication interface, the consumer credit report file to the first credit reporting agency; and determine, based on a result of the analysis and the modification, a file health check score for the consumer credit report file.

The consumer credit report file may be automatically modifiable so as to ensure that the consumer credit report file does not violate the at least one second tier rule.

The processor may be further configured to: when the consumer credit report file violates the at least one first tier rule, prompt a user to provide an input that is usable for replacing at least one invalid value that is not includible in the consumer credit report file.

The processor may be further configured to: receive, via the communication interface, a dispute inquiry that relates to the first set of data; analyze the consumer credit report file and the dispute inquiry to determine an accuracy of the first set of data; and when a determination is made that the first set of data includes at least one inaccurate data item, modify the at least one inaccurate data item in order to resolve the dispute inquiry.

The processor may be further configured to: generate, based on the modification of the at least one inaccurate data item, a response to the dispute inquiry; and transmit, via the communication interface to at least one predetermined entity, a notification of the response to the dispute inquiry.

The dispute inquiry may include at least one from among a first inquiry that relates to a discrepancy in a transaction payment history and a second inquiry that relates to incorrect information included in a credit report.

The processor may be further configured to modify the consumer credit report file by inputting the consumer credit report file to an AI model that is trained to perform the modification based on historical violations of the series of rules.

The processor may be further configured to determine the health check score by: assessing each respective field included in the consumer credit report file to determine whether the respective field is a key field; assigning, to each respective field included in the consumer credit report file, a respective weight; evaluating each respective field to determine a respective percentage value that indicates an adherence to a corresponding standard; for each respective field, combining the respective weight with the respective percentage value to determine a respective field-specific health check score; and calculating the file health check score based on a combination of the field-specific health check scores for all fields included in the consumer credit report file.

When a particular field is determined as being a key field, the respective weight for a value that corresponds to a first tier rule may be equal to one from among 1.0, 1.25, 1.5, 1.75, and 2.0, and the respective weight for a value that corresponds to a second tier rule may be equal to 0.75; and when the particular field is determined as not being a key field, the respective weight for the value that corresponds to the first tier rule may be equal to 1.0, and the respective weight for the value that corresponds to the second tier rule may be equal to 0.50.

According to yet another aspect of the present disclosure, a non-transitory computer readable storage medium storing instructions for generating a file that is suitable for submission to a first credit reporting agency is provided. The storage medium includes executable code which, when executed by a processor, may cause the processor to: receive a first set of data that relates to a consumer; generate a consumer credit report file by using the first set of data; analyze the consumer credit report file to determine whether the consumer credit report file violates at least one rule from among a series of rules, wherein the series of rules includes at least one first tier rule that relates to invalid values that are not includible in the consumer credit report file and at least one second tier rule that relates to illogical values that are updatable in order to become includible in the consumer credit report file; determine, based on a result of the analysis of the consumer credit report file, whether the consumer credit report file is compliant with applicable governmental regulations; when a determination is made that the consumer credit report file is not compliant with at least one from among the applicable governmental regulations, modify the consumer credit report file such that, as modified, the consumer credit report file is fully compliant with all of the applicable governmental regulations; transmit the consumer credit report file to the first credit reporting agency; and determine, based on a result of the analysis and the modification, a file health check score for the consumer credit report file.

The consumer credit report file may be automatically modifiable so as to ensure that the consumer credit report file does not violate the at least one second tier rule.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for accurately generating a credit report file that satisfies all applicable governmental regulations prior to transmitting the file to a credit reporting agency while ensuring that the generated credit report is accurate and error free, according to an embodiment.

FIG. 2 illustrates a diagram of a network environment for accurately generating a credit report file that satisfies all applicable governmental regulations prior to transmitting the file to a credit reporting agency while ensuring that the generated credit report is accurate and error free, according to an embodiment.

FIG. 3 illustrates a system diagram of a system for accurately generating a credit report file that satisfies all applicable governmental regulations prior to transmitting the file to a credit reporting agency while ensuring that the generated credit report is accurate and error free, according to an embodiment.

FIG. 4 illustrates a process diagram of a process for accurately generating a credit report file that satisfies all applicable governmental regulations prior to transmitting the file to a credit reporting agency while ensuring that the generated credit report is accurate and error free, according to an embodiment.

FIG. 5 illustrates a flow diagram of a process for accurately generating a credit report file that satisfies all applicable governmental regulations prior to transmitting the file to a credit reporting agency while ensuring that the generated credit report is accurate and error free, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units and/or modules of the example embodiments may be physically combined into more complex blocks, units, and/or modules without departing from the scope of the present disclosure.

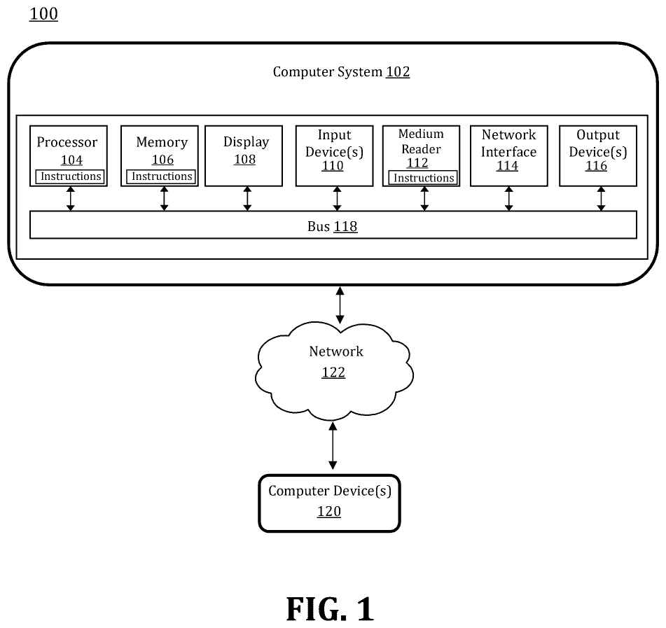

FIG. 1 illustrates a system 100 for accurately generating a credit report file that satisfies all applicable governmental regulations prior to transmitting the file to a credit reporting agency while ensuring that the generated credit report is accurate and error free, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the credit bureau reporting module implemented by the system 100 may allow for accurately generating a credit report file that satisfies all applicable governmental regulations prior to transmitting the file to a credit reporting agency while ensuring that the generated credit report is accurate and error free. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

As described herein, various embodiments provide optimized methods and systems for accurately generating a credit report file that satisfies all applicable governmental regulations prior to transmitting the file to a credit reporting agency.

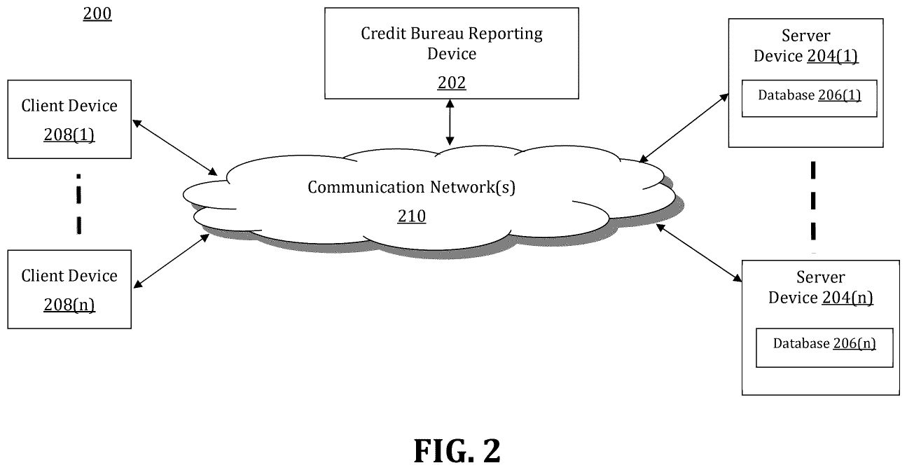

Referring to FIG. 2, a schematic of a network environment 200 for accurately generating a credit report file that satisfies all applicable governmental regulations prior to transmitting the file to a credit reporting agency while ensuring that the generated credit report is accurate and error free is illustrated, according to an embodiment. In some embodiments, the method may be executable on any networked computer platform, such as, for example, a personal computer (PC).

In some embodiments, the above-described problems associated with conventional tools may be overcome by implementing a credit bureau reporting device 202 as illustrated in FIG. 2 that may be configured for accurately generating a credit report file that satisfies all applicable governmental regulations prior to transmitting the file to a credit reporting agency while ensuring that the generated credit report is accurate and error free, but the disclosure is not limited thereto.

The credit bureau reporting device 202 may include one or more computer systems 102, as described with respect to FIG. 1, which in aggregate provide the necessary functions.

The credit bureau reporting device 202 may store one or more applications that can include executable instructions that, when executed by the credit bureau reporting device 202, cause the credit bureau reporting device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the credit bureau reporting device 202 itself, may be located in virtual server(s) running in a cloud-based computing environment rather than being tied to one or more specific physical network computing devices. Also, the application(s) may be running in one or more virtual machines (VMs) executing on the credit bureau reporting device 202. Additionally, in one or more embodiments of this technology, virtual machine(s) running on the credit bureau reporting device 202 may be managed or supervised by a hypervisor.

In the network environment 200 of FIG. 2, the credit bureau reporting device 202 may be coupled to a plurality of server devices 204(1)-204(n) that hosts a plurality of databases 206(1)-206(n), and also to a plurality of client devices 208(1)-208(n) via communication network(s) 210. A communication interface of the credit bureau reporting device 202, such as the network interface 114 of the computer system 102 of FIG. 1, operatively couples and communicates between the credit bureau reporting device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the credit bureau reporting device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The credit bureau reporting device 202 may be a standalone device or integrated with one or more other devices or apparatuses, such as one or more of the server devices 204(1)-204(n), for example. In one example, the credit bureau reporting device 202 may be hosted by one of the server devices 204(1)-204(n), and other arrangements are also possible. Moreover, one or more of the devices of the credit bureau reporting device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the credit bureau reporting device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the credit bureau reporting device 202 that may efficiently provide a platform for automatically generating a credit report file that satisfies all applicable governmental regulations prior to transmitting the file to a credit reporting agency, but the disclosure is not limited thereto.

The client devices 208(1)-208(n) may run interface applications, such as standard web browsers or standalone client applications, which may provide an interface to communicate with the credit bureau reporting device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the credit bureau reporting device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the credit bureau reporting device 202, the server devices 204(1)-204(n), or the client devices 208(1)-208(n), for example, may be configured to operate as virtual instances on the same physical machine. For example, one or more of the credit bureau reporting devices 202, the server devices 204(1)-204(n), or the client devices 208(1)-208(n) may operate on the same physical device rather than as separate devices communicating through communication network(s) 210. Additionally, there may be more or fewer credit bureau reporting devices 202, server devices 204(1)-204(n), or client devices 208(1)-208(n) than illustrated in FIG. 2. In some embodiments, the credit bureau reporting device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

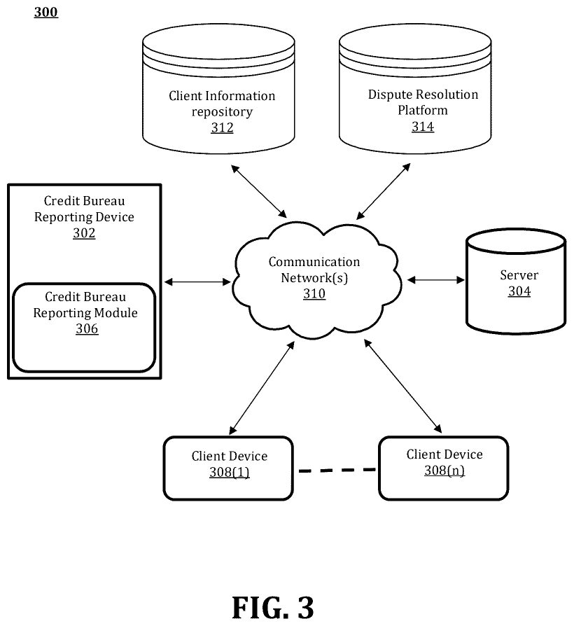

FIG. 3 illustrates a system diagram for accurately generating a credit report file that satisfies all applicable governmental regulations prior to transmitting the file to a credit reporting agency while ensuring that the generated credit report is accurate and error free, in accordance with an embodiment.

As illustrated in FIG. 3, the system 300 may include a credit bureau reporting device 302 within which a credit bureau reporting module 306 is embedded, a server 304, a client information repository 312, a dispute resolution platform 314, a plurality of client devices 308(1) . . . 308(n), and a communication network 310.

In some embodiments, the credit bureau reporting device 302 including the credit bureau reporting module 306 may be connected to the server 304, the client information repository 312, and the dispute resolution platform 314 via the communication network 310. The credit bureau reporting device 302 may also be connected to the plurality of client devices 308(1) . . . 308(n) via the communication network 310, but the disclosure is not limited thereto. The client information repository 312 and the dispute resolution platform 314 may include one or more repositories or databases.

In an embodiment, the credit bureau reporting device 302 is described and shown in FIG. 3 as including the credit bureau reporting module 306, although it may include other rules, policies, modules, databases, or applications, for example. In some embodiments, the client information repository 312 and the dispute resolution platform 314 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The client information repository 312 and the dispute resolution platform 314 may be a mainframe database, a log database that may produce programming for searching, monitoring, and analyzing machine-generated data via a web interface, but the disclosure is not limited thereto.

In some embodiments, the credit bureau reporting module 306 may be configured to receive real-time feed of data from the plurality of client devices 308(1) . . . 308(n) and secondary sources via the communication network 310.

The credit bureau reporting module 306 may be configured to: receive a first set of data that relates to a consumer; generate a consumer credit report file by using the first set of data; analyze the consumer credit report file to determine whether the consumer credit report file violates at least one rule from among a series of rules, wherein the series of rules includes at least one first tier rule that relates to invalid values that are not includible in the consumer credit report file and at least one second tier rule that relates to illogical values that are updatable in order to become includible in the consumer credit report file; determine, based on a result of the analysis of the consumer credit report file, whether the consumer credit report file is compliant with applicable governmental regulations; when a determination is made that the consumer credit report file is not compliant with at least one from among the applicable governmental regulations, modify the consumer credit report file such that, as modified, the consumer credit report file is fully compliant with all of the applicable governmental regulations; transmit the consumer credit report file to the first credit reporting agency; and determine, based on a result of the analysis and the modification, a file health check score for the consumer credit report file.

The plurality of client devices 308(1) . . . 308(n) are illustrated as being in communication with the credit bureau reporting device 302. In this regard, the plurality of client devices 308(1) . . . 308(n) may be “clients” (e.g., customers) of the credit bureau reporting device 302 and are described herein as such. Nevertheless, it is to be known and understood that the plurality of client devices 308(1) . . . 308(n) need not necessarily be “clients” of the credit bureau reporting device 302, or any entity described in association therewith herein. Any additional or alternative relationship may exist between either or both plurality of client devices 308(1) . . . 308(n) and the credit bureau reporting device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) . . . 308(n) may communicate with the credit bureau reporting device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The credit bureau reporting device 302 may be the same or similar to the credit bureau reporting device 202 as described with respect to FIG. 2, including any features or combination of features described with respect thereto.

Upon being started, the credit bureau reporting device 302 executes a process for accurately generating a credit report file that satisfies all applicable governmental regulations prior to transmitting the file to a credit reporting agency while ensuring that the generated credit report is accurate and error free.

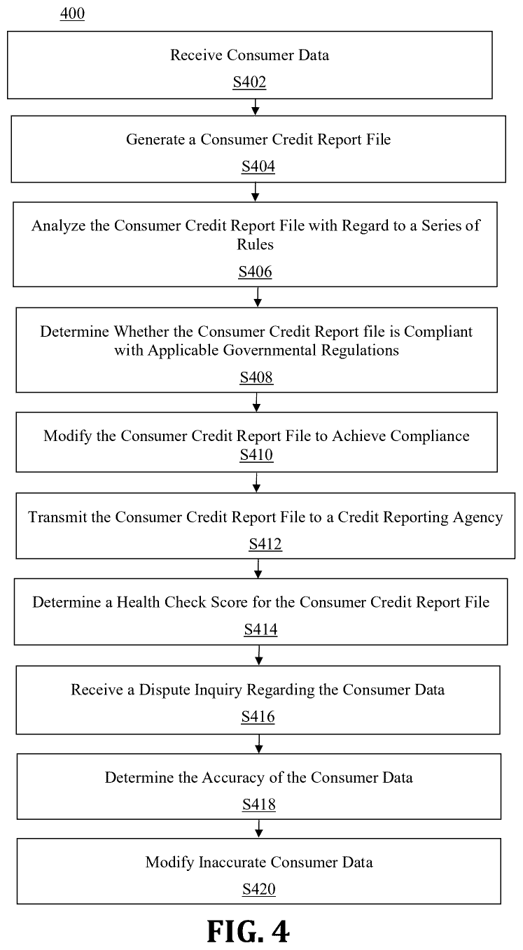

Referring to FIG. 4, a process 400 for accurately generating a credit report file that satisfies all applicable governmental regulations prior to transmitting the file to a credit reporting agency while ensuring that the generated credit report is accurate and error free is illustrated, according to an embodiment.

In process 400 of FIG. 4, at step S402, the credit bureau reporting device 302 may receive a data set that relates to consumer data. In an embodiment, the consumer may be a client of a financial institution. For example, the consumer may be an individual client of the financial institution. In an embodiment, the data set may include a plurality of information (e.g., forty-six separate data items) required by various regulations and standards (e.g., FCRA and/or CDIA furnishing guide). For example, the data set may include credit payment history data (e.g., an indication of a current or delinquent payment status), client information, account history and behavior, and/or transactions between the consumer and the financial institution over a predetermined period of time. In some embodiments, the data set may include the data that is reported to credit agencies for generating a credit report that relates to the consumer.

At step S404, the credit bureau reporting device 302 may be configured to generate a consumer credit report file using the received data set. In an embodiment, the credit bureau reporting device 302 may generate the consumer credit report file by automatically converting the data set into a predefined format. In some embodiments, the data set may be converted into a format that is defined and accepted by a credit agency. In an embodiment, the consumer credit report file may be formatted to a standardized format used by at least one credit reporting agency.

At step S406, the credit bureau reporting device 302 may be configured to analyze the consumer credit report file to determine whether the consumer credit report file violates at least one rule from a series of rules. The series of rules may include at least one first tier rule and at least one second tier rule. The first tier rule may be one or more rules that determine whether the consumer credit report file contains invalid values that may not be included in the consumer credit report file. For example, according to an embodiment, a first tier rule may include—if account status contains certain values (e.g., 13, 65, 88, 89, 94 or 95) and the payment rating is blank, route to queue for review. The second tier rule may be one or more rules that determine whether the consumer credit report file contains illogical values that may be updated in order to be included in the consumer credit report file. For example, according to an embodiment, a second tier rule may include—if account status does not contain certain values (e.g., 13, 65, 88, 89, 94 or 95) and the payment rating is not blank, then blank fill, include on a furnishing file, and route to queue for management review. These rules may ensure that the consumer credit report file is acceptable by at least one credit reporting agency and may ensure that the credit report file is in compliance with applicable governmental regulations. The rules may ensure that the credit report file is in compliance with various regulations and standards such as FCRA and/or CDIA furnishing guide. Moreover, the rules may ensure that the credit report file is formatted to include a single header record, a data record, and a trailer record. In an embodiment, the rules may ensure that the credit report file complies with Metro2 requirements.

At step S408, the credit bureau reporting device 302 may be configured to determine whether the consumer credit report file is compliant with applicable governmental regulations based on the analyzing of the consumer credit report file with regard to the rules. For example, the credit bureau reporting device 302 may apply the series of rules, including the first tier rules and the second tier rules, to the consumer credit report file, and if the consumer credit report file is not in violation of any of the rules, the credit bureau reporting device 302 can report that the consumer credit report file is compliant with the applicable governmental regulations. In some embodiments, the credit bureau reporting device 302 may be configured to determine whether the consumer credit report file is acceptable by at least one credit reporting agency. In an embodiment, the credit bureau reporting device 302 may be configured to determine whether the credit report file is in compliance with various regulations and standards (e.g., FCRA and/or CDIA furnishing guide). In an embodiment, the credit bureau reporting device 302 may be configured to determine whether the credit report file is formatted to include a single header record, a data record, and a trailer record. The credit bureau reporting device 302 may be configured to determine whether the credit report file complies with Metro2 requirements. The credit bureau reporting device 302 may process the consumer credit report file through a series of credit agency formatting validation logic that correspond to the first and second tier rules. For example, the credit bureau reporting device 302 may use the series of credit agency formatting validation logic to recognize first tier rule violations in which a value is invalid, for which the account may not be included on furnishing file and may then be queued for routing. The credit bureau reporting device 302 may also use the series of credit agency formatting validation logic to recognize second tier rule violations in which the value is illogical, for which the account may be updated and transmitted.

At step S410, the credit bureau reporting device 302 may modify the consumer credit report file to be compliant with the applicable governmental regulations. In an embodiment, when a second tier rule violation has been identified, the credit bureau reporting device 302 may automatically modify the consumer credit report file so that the file is no longer in violation of the second tier rule. For example, if the credit bureau reporting device 302 determines at S408 that the account status does not contain certain values (e.g., 13, 65, 88, 89, 94 or 95) and the payment rating is not blank, which may be a second tier rule violation, the credit bureau reporting device 302 may modify the consumer credit report file to blank fill the payment rating to ensure that the consumer credit report file is no longer in violation of the second tier rule. In other words, the credit bureau reporting device 302 may fill the blank of the payment rating so that the credit report file may be transmitted to a credit reporting agency. In some embodiments, when a first tier rule violation has been identified, the credit bureau reporting device 302 may prompt a user to provide an input to replace the invalid value that cannot be included in the consumer credit report file. For example, if the credit bureau reporting device 302 determines at S408 that the account status contains certain values (e.g., 13, 65, 88, 89, 94 or 95) and the payment rating is blank, which may be a first tier rule violation, the credit bureau reporting device 302 may prompt a user to input the appropriate value for the payment rating to ensure that the consumer credit report file is no longer in violation of the first tier rule. In other words, if the payment rating is blank, the account will not furnish and will route to a tier one queue. In an embodiment, the credit bureau reporting device 302 may include an AI model that is trained to perform the modifying based on historical violations of the series of rules. The consumer credit report file may be input to the AI model in order to modify the consumer credit report file to be compliant with the applicable governmental regulations. In an embodiment, the credit bureau reporting device 302 may be configured to employ extended credit agency formatting (e.g., Metro 2) logic comparison prior to transmitting the consumer credit report file.

At step S412, the credit bureau reporting device 302 may transmit the consumer credit report file to at least one credit reporting agency. In an embodiment, the credit reporting agency may be at least one from among Experian, Equifax, Transunion, and Innovis. In some embodiments, the transmitting of the consumer credit report file by the credit bureau reporting device 302 may either be suppressed and sent for review within the organization by an appropriate manager or transmitted to the credit reporting agency with modifications made by the credit bureau reporting device 302, based upon the tier of the rule violation.

At step S414, the credit bureau reporting device 302 may determine a health check score for the consumer credit report file. Specifically, each respective field included in the consumer credit report file may be assessed to determine whether the respective field is a key field based on the analyzing of the consumer credit report file with regard to the rules. While the health check scores reflect all the data fields, key fields may provide visibility into FCRA required fields that have the most significant potential customer impact. The selected key field may align with the frequently asked questions (FAQ's) for furnishing as presented in the CDIA furnishing guide. The credit bureau reporting device 302 may then assign a respective weight to each respective field included in the consumer credit report file. Next, the credit bureau reporting device 302 may evaluate each respective field to determine a respective percentage value that indicates an adherence to a corresponding standard. The credit bureau reporting device 302 may then, for each respective field, combine the respective weight with the respective percentage value to determine a respective field-specific health check score. Then, the credit bureau reporting device 302 may calculate the file health check score based on a combination of the field-specific health check scores for all fields include in the consumer credit report file.

In an embodiment, each tier may have a predetermined weight/score associated with it. In some embodiments, the tier weights may be based on whether the issue causing the illogical result was pre-existing in the system. The tier weights may also be based on whether the illogical result has an impact with regard to a regulation and/or standard (e.g., FCRA), or whether it just has a general impact. In some embodiments, when a particular field is determined as being a key field, the respective weight for a value that corresponds to a first tier rule may be equal to one from among 1.0, 1.25, 1.5, 1.75, and 2.0, and the respective weight for a value that corresponds to a second tier rule may be equal to 0.75. In an embodiment, when the particular field is determined as not being a key field, the respective weight for the value that corresponds to the first tier rule may be equal to 1.0, and the respective weight for the value that corresponds to the second tier rule may be equal to 0.50. In some embodiments, the health check score may be assigned to or associated with a corresponding group that is associated with the particular field for which the rule violation occurred and is within an organization for which the consumer credit report file belongs. In other words, the health check score may be used to grade or rate groups or departments of the organization based on the number of rule violations that occur within that group. The corresponding group may be selected based on criteria relating to the received data set of consumer data. Each group may correspond to a line of business (LOB) from within the organization. In an embodiment, the health check score may be used to assess each group of the organization. In an embodiment, the health check scores may be used to determine which rules of the series of rules are working properly and which rules need to be improved. Additionally, identified violations of the series of rules may be stored and used for the construction of the health check scores. The identification and storing of these rule violations may serve as an evaluation or score of credit agency formatting adherence. Moreover, health check scores will serve to track credit agency formatting adherence for transmitting the consumer credit report file, with defined benchmarks/standards for quality performance, and may serve to guide ongoing feedback for progress toward those standards.

TABLE 1
FCRA Key Fields and Rationale

| Record | | | | Tier 1 | Tier 2 |
|---|---|---|---|---|---|
| Type | Field | Field Name | Rationale | Weight | Weight |
| Base | 10 | Date | The date the account was originally opened. | 1.5 | 0.75 |
| | | Opened | Valid date opened must be reported - field cannot | | |
| | | | be zero or blank filled, nor contain a date in the | | |
| | | | future. If no valid date trade will be rejected | | |
| Base | 13 | Terms | Contains the duration of credit extended. | 1 | 0.75 |
| | | Duration | Line of Credit, Installment, Mortgage, Open, | | |
| | | | Revolving. | | |
| Base | 14 | Terms | Denotes how often a payment is due. | 1 | 0.75 |
| | | Frequency | D = Deferred, P = Single Payment Loan, | | |
| | | | W = Weekly, B = Biweekly, E = Semimonthly, | | |
| | | | M = Monthly, L = Bimonthly, Q = Quarterly, | | |
| | | | T = Tri-annually, S = Semiannually, Y = Annually | | |
| Base | 15 | Scheduled | The dollar amount of the scheduled monthly | 1 | 0.75 |
| | | Monthly | payment due for the reporting period, whether | | |
| | | Payment | principal, interest only or a combination of the | | |
| | | Amount | two. When a balloon payment is also due during | | |
| | | | the reporting period, the balloon payment amount | | |
| | | | should be included to represent the entire | | |
| | | | monthly payment amount due. | | |
| Base | 16 | Actual | The dollar amount of the monthly payment | 1 | 0.75 |
| | | Payment | actually received for this reporting period in | | |
| | | Amount | whole dollars only. | | |
| Base | 17A | Account | Contains the status code that properly identifies | 2 | 0.75 |
| | | Status | the current condition of the account as of the Date | | |
| | | | of Account Information. | | |
| Base | 17B | Payment | Contains a code that properly identifies whether | 1.5 | 0.75 |
| | | Rating | the account was current, past due, in collections | | |
| | | | or charged off prior to the status and within the | | |
| | | | current month's reporting period. | | |
| Base | 18 | Payment | Contains up to 24 months of consecutive payment | 2 | 0.75 |
| | | History | activity for the previous 24 reporting periods | | |
| | | Profile | prior to the Date of Account Information (Field | | |
| | | | 24) being reported. | | |
| Base | 19 | Special | Used in conjunction with Account Status (Field | 1.25 | 0.75 |
| | | Comment | 17A) and Payment Rating (Field 17B) to further | | |
| | | | define the account (e.g., closed accounts or | | |
| | | | adjustments pending). | | |
| Base | 20 | Compliance | Furnishing of a condition that is required for | 1.75 | 0.75 |
| | | Condition | legal compliance. This condition may refer to | | |
| | | Code | accounts closed at consumer's request, accounts | | |
| | | | in dispute under the Fair Credit Reporting Act | | |
| | | | (FCRA), the Fair Debt Collection Practices Act | | |
| | | | (FDCPA) or the Fair Credit Billing Act | | |
| | | | (FCBA). | | |
| Base | 21 | Current | The outstanding current balance on the account | 1 | 0.75 |
| | | Balance | as of the Date of Account Information. The | | |
| | | | Current Balance should contain the principal | | |
| | | | balance including Balloon Payment Amounts | | |
| | | | (when applicable), as well as applicable interest, | | |
| | | | late charges, fees, insurance payments and | | |
| | | | escrow that are due during the current reporting | | |
| | | | period. The Current Balance may exceed the | | |
| | | | Highest Credit, Original Loan Amount or Credit | | |
| | | | Limit. | | |
| Base | 22 | Amount | The total amount of payments that are 30 days | 1 | 0.75 |
| | | Past Due | or more past due in whole dollars only. This | | |
| | | | field should include late charges and fees, if | | |
| | | | applicable. | | |
| Base | 23 | Original | The original amount charged to loss, regardless | 1 | 0.75 |
| | | Charge-off | of the declining balance. If payments are | | |
| | | Amount | received from the consumer, report the | | |
| | | | outstanding balance in the Current Balance and | | |
| | | | Amount Past Due fields. | | |
| Base | 25 | FCRA | The date of the first 30-day delinquency that led | 2 | 0.75 |
| | | Compliance/ | to the status being reported. The DOFD is used | | |
| | | Date of First | by the consumer reporting agencies for purging | | |
| | | Delinquency | purposes. | | |
| | | (DOFD) | | | |
| Base | 26 | Date Closed | The date the account was closed to further | 1.75 | 0.75 |
| | | | purchases, paid in full, transferred or sold. For | | |
| | | | Line of Credit, Open or Revolving accounts, | | |
| | | | there may be a balance due. | | |
| Base | 37 | Equal Credit | The relationship of the primary consumer to the | 1.5 | 0.75 |
| | | Opportunity | account and designates the account as joint, | | |
| | | Act (ECOA) | individual, etc., in compliance with the ECOA. | | |
| | | Code | | | |
| Base | 38 | Consumer | Contains a value that indicates a special | 1.75 | 0.75 |
| | | Information | condition of the account that applies to the | | |
| | | Indicator | primary consumer. This special condition may | | |
| | | | be that a bankruptcy was filed, discharged, | | |
| | | | dismissed, or withdrawn; a debt was reaffirmed; | | |
| | | | or the consumer cannot be located or is now | | |
| | | | located. | | |
| J1 | 10 | ECOA Code | Defines the relationship of the associated | 1.5 | 0.75 |
| | | | consumer to the account and designates the | | |
| | | | account as joint, individual, etc., in compliance | | |
| | | | with the Equal Credit Opportunity Act. | | |
| J1 | 11 | Consumer | Contains a value that indicates a special | 1.75 | 0.75 |
| | | Information | condition of the account that applies to the | | |
| | | Indicator | associated consumer. This special condition may | | |
| | | | be that a bankruptcy was filed, discharged, | | |
| | | | dismissed, or withdrawn; a debt was reaffirmed; | | |
| | | | or the consumer cannot be located or is now | | |
| | | | located. | | |
| J2 | 10 | ECOA Code | Defines the relationship of the associated | 1.5 | 0.75 |
| | | | consumer to the account and designates the | | |
| | | | account as joint, individual, etc., in compliance | | |
| | | | with the Equal Credit Opportunity Act. | | |
| J2 | 11 | Consumer | Contains a value that indicates a special | 1.75 | 0.75 |
| | | Information | condition of the account that applies to the | | |
| | | Indicator | associated consumer. This special condition may | | |
| | | | be that a bankruptcy was filed, discharged, | | |
| | | | dismissed, or withdrawn; a debt was reaffirmed; | | |
| | | | or the consumer cannot be located or is now | | |
| | | | located. | | |

In an embodiment, the credit bureau reporting device 302 may be configured to use health check scores to provide visibility into consumer credit report file transmittal adherence to credit agency formatting logic prior to transmittal. In some embodiments, thresholds may be used for all fields including key fields and assigned a rating of “On Track,” “Warning,” or “Attention Needed”, by the credit bureau reporting device 302. In an embodiment, key fields may be required to have a 98% or greater accuracy score to be considered “On Track” as they represent significant contributions to a consumer's credit portfolio and in many cases are FCRA related. The overall health check score may also utilize the higher percentage for scoring. In some embodiments, non-key fields may be required to have a 95% or greater accuracy score to be considered “On Track.” In an embodiment, the credit bureau reporting device 302 may use analytical processing and querying software (e.g., Alteryx and Tableau) to drill down to the detail of a data field by user selection. This may allow for on demand analysis and enable early detection and modification of the series of rules.

In an embodiment, the health check scores may include the following components: 1) fields—all credit agency formatting fields utilized in all furnishing segments may be evaluated and scored; 2) Scores—each field may receive a score to reflect adherence to a standard; and 3) weights—the credit bureau reporting device 302 may employ weights, applied to the health check score, emphasizing the contribution of a particular field to the final outcome or result and thereby highlighting those aspects in comparison to others in the analysis. In an embodiment, weights may range from 0.5 to 2.0. Non-key fields may have a weighted value of 1.0 for a tier one and 0.50 for a tier two. Key fields may range from 1.0, 1.25, 1.50, 1.75 through 2.0 for tier one and 0.75 for a tier two. In an embodiment, tier two opportunities may be data items that have been modified/corrected prior to transmitting the consumer credit report file to the credit reporting agency to adhere to/meet the credit agency formatting standard. For this reason, tier two rule violations may not contribute to the health check score at a full value.

At step S416, the credit bureau reporting device 302 may receive a dispute inquiry that relates to the consumer data. In some embodiments, the dispute inquiry may be from a respective consumer/client. In an embodiment, the consumer may be disputing at least one transaction from the payment history data. In another embodiment, the consumer may be disputing information that is presented on the consumer credit report file. For example, the client may assert that information on the consumer credit report file is incorrect. In an embodiment, the dispute inquiry may relate to a discrepancy in the consumer data. In some embodiments, the dispute inquiry may be received from a predetermined internet resource that transmits and receives dispute information. For example, a client may submit a dispute through the internet resource regarding the client's payment history data, and the internet resource may then transmit the dispute to the credit bureau reporting device 302. In an embodiment, the dispute inquiry may be received from the electronic Online Solution for Complete and Accurate Reporting (e-OSCAR). In some embodiments, the credit bureau reporting device 302 may include a user interface that displays the dispute inquiry once the dispute inquiry is created. The credit bureau reporting device 302 may create a workflow and compile all the information about the dispute, which may be displayed by the user interface so that all the relevant information is readily accessible.

At step S418, the credit bureau reporting device 302 may be configured to analyze the dispute inquiry and the consumer credit report file to determine the accuracy of the consumer data received at step S402. The credit bureau reporting device 302 may analyze the consumer data with respect to the dispute inquiry to determine if there is an error or an inaccurate data item with the consumer data. For example, in a non-limiting embodiment, in which a consumer has raised a dispute inquiry regarding the accuracy of the consumer credit report file that was transmitted to a credit reporting agency, the consumer data on the consumer credit report file that was reported to the credit reporting agency may indicate a delinquent status, but the credit bureau reporting device 302 may determine that the client's account actually has zero dollars past due. The credit bureau reporting device 302 may then determine that the delinquent status is illogical, based on the fact that the client's account has zero dollars past due, and that the consumer data may need correction.

Then, at step S420, when a determination is made by the credit bureau reporting device 302 that the first set of data includes at least one inaccurate data item, based on the analysis, the credit bureau reporting device 302 may be configured to modify the at least one inaccurate data item in order to resolve the dispute inquiry. In some embodiments, the credit bureau reporting device 302 may be configured to automatically modify or fix the discrepancies/inaccurate data items to resolve the dispute inquiry. In an embodiment, the file may be sent to an appropriate group or line of business within the organization, so that a team or person from the appropriate group may address and fix the issue. In an embodiment, the credit bureau reporting device 302 may be configured to generate and transmit a notification of the determined resolution of the dispute inquiry. The generated notification may be transmitted to the corresponding consumer/client whose data was involved in the dispute inquiry.

Deployment of the credit bureau reporting device 302 may enhance data control capabilities and provide transparency into data quality. Additionally, the credit bureau reporting device 302 may provide several benefits for reporting information to credit reporting agencies including: central management of the consumer credit report file transmittal process; enhanced accuracy and integrity of transmitting data to lower the amount of credit reporting agency data rejects and transformations; adherence to industry standards/operating rules with regard to transmitting data; continuous process improvement by way of data issue feedback loops; control established pre-transmittals that serve to reduce the need for post transmittal mitigation; improve control capabilities; and adhere to the provisions of the FCRA.

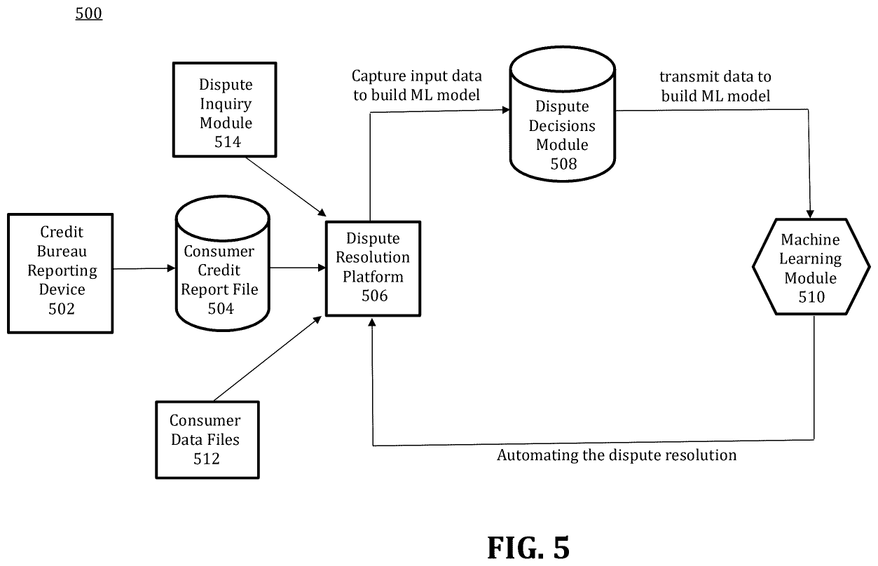

Referring to FIG. 5, a flow diagram 500 for accurately generating a credit report file that satisfies all applicable governmental regulations prior to transmitting the file to a credit reporting agency while ensuring that the generated credit report is accurate and error free is illustrated, according to an embodiment. Particularly, flow diagram 500 illustrates a system for performing steps S418 and S420 of FIG. 4, according to an embodiment.

As illustrated in FIG. 5, the credit bureau reporting device 502 may transmit the consumer credit report file 504 to be received by a dispute resolution platform (DRP) 506. The DRP 506 may also receive at least one consumer data file 512 that relates to consumer spending, income, and/or payments. The consumer data file 512 may relate to and be transmitted from a variety of different organizations, departments, and/or LOBs (e.g., banking/credit card LOB, automative loan LOB, mortgage/housing loan LOB, etc.). A dispute inquiry module 514 may also transmit a dispute inquiry to be received by the DRP 506. The dispute inquiry may be manually input by the consumer with regard to information that was transmitted to a credit reporting agency from their consumer report file 504. The data received by the DRP 506 may then be transmitted to a dispute decisions module 508 where historic data relating to previous dispute inquiries is captured. All the received and captured data is then transmitted to the machine learning module 510. The machine module 510 may then generate corrections to be implemented by the DRP 506 for automating dispute resolution. In an embodiment, the DRP 506 may leverage multiple data sources and present the relevant information needed for users to resolve credit reporting disputes accurately and efficiently. The DRP 506 may also facilitate a consistent research and resolution experience across multiple products/LOBs by leveraging the data within the consumer credit report file 504 that was generated by the credit bureau reporting device 502. Standard formatting, display, and retention of data may allow for the leveraging of machine learning that may support decisions to update credit reporting and allow for the expedited completion of corrections through automated processing. The DRP 506 may incorporate AI assistants that can provide relevant procedure and policy details to further support decision making while resolving disputes.

Accordingly, with this technology, an optimized process for accurately generating a credit report file that satisfies all applicable governmental regulations prior to transmitting the file to a credit reporting agency while ensuring that the generated credit report is accurate and error free is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for generating a file that is suitable for submission to a first credit reporting agency, the method being implemented by at least one processor, the method comprising:
receiving, by the at least one processor, a first set of data that relates to a consumer;
generating, by the at least one processor, a consumer credit report file by using the first set of data, wherein the generating of the consumer credit report file includes automatically converting the first set of data into a predefined format that is accepted by the first credit reporting agency;
analyzing, by the at least one processor, the consumer credit report file to determine whether the consumer credit report file violates at least one rule from among a series of rules, wherein the series of rules includes at least one first tier rule that identifies first values that are not includible in the consumer credit report file and at least one second tier rule that identifies second values that are updatable in order to become includible in the consumer credit report file;
integrating, by that at least one processor, credit agency validation logic, associated with the first credit reporting agency, to recognize a violation of each rule from among the series of rules;
determining, by the at least one processor based on results of the analyzing of the consumer credit report file and the integrating of the credit agency validation logic, whether the consumer credit report file is compliant with applicable governmental regulations;
when a determination is made that the consumer credit report file is not compliant with at least one from among the applicable governmental regulations, modifying, by the at least one processor, the consumer credit report file such that, as modified, the consumer credit report file is fully compliant with all of the applicable governmental regulations, wherein the modifying includes integrating an artificial intelligence (AI) model and the credit agency validation logic to perform the modifying and to verify compliance with the applicable governmental regulations;
transmitting, by the at least one processor, the consumer credit report file to the first credit reporting agency; and
determining, by the at least one processor based on a result of the analyzing and the modifying, a first score that provides a rating for the consumer credit report file.

2. The method of claim 1, wherein the consumer credit report file is automatically modifiable so as to ensure that the consumer credit report file does not violate the at least one second tier rule.

3. The method of claim 1, further comprising:
when the consumer credit report file violates the at least one first tier rule, prompting, by the at least one processor, a user to provide an input that is usable for replacing at least one invalid value that is not includible in the consumer credit report file.

4. The method of claim 1, further comprising:
receiving, by the at least one processor, from an electronic Online Solution for Complete and Accurate Reporting (e-OSCAR) portal, a dispute inquiry that relates to the first set of data;
creating, by the at least one processor, a workflow that compiles information related to the dispute inquiry;
analyzing, by the at least one processor, the consumer credit report file, the created workflow, and the dispute inquiry to determine an accuracy of the first set of data; and
when a determination is made that the first set of data includes at least one inaccurate data item, automatically modifying, by the at least one processor, the at least one inaccurate data item in order to resolve the dispute inquiry.

5. The method of claim 4, further comprising:
capturing, by the at least one processor, historical data related to prior dispute inquiries;
transmitting, by the at least one processor, the first set of data and the historical data to a machine learning model;
generating, by the at least one processor via the machine learning model, corrections to the first set of data;
generating, based on the modifying of the at least one inaccurate data item, a response to the dispute inquiry; and
transmitting, by the at least one processor to at least one predetermined entity, a notification of the response to the dispute inquiry.

6. The method of claim 4, wherein the dispute inquiry comprises at least one from among a first inquiry that relates to a discrepancy in a transaction payment history and a second inquiry that relates to incorrect information included in a credit report.

7. (canceled)

8. The method of claim 1, wherein the determining of the first score comprises:
assessing each respective field included in the consumer credit report file to determine whether the respective field is a key field;
assigning, to each respective field included in the consumer credit report file, a respective weight;
evaluating each respective field to determine a respective percentage value that indicates an adherence to a corresponding standard;
for each respective field, combining the respective weight with the respective percentage value to determine a respective field-specific score; and
calculating the first score based on a combination of the field-specific scores for all fields included in the consumer credit report file.

9. The method of claim 8, wherein when a particular field is determined as being a key field, the respective weight for a value that corresponds to a first tier rule is equal to one from among 1.0, 1.25, 1.5, 1.75, and 2.0, and the respective weight for a value that corresponds to a second tier rule is equal to 0.75; and when the particular field is determined as not being a key field, the respective weight for the value that corresponds to the first tier rule is equal to 1.0, and the respective weight for the value that corresponds to the second tier rule is equal to 0.50.

10. A computing apparatus for generating a file that is suitable for submission to a first credit reporting agency, the computing apparatus comprising:
a processor;
a memory; and
a communication interface coupled to each of the processor and the memory,
wherein the processor is configured to:
receive, via the communication interface, a first set of data that relates to a consumer;
generate a consumer credit report file by using the first set of data, wherein the generating of the consumer credit report file includes automatically converting the first set of data into a predefined format that is accepted by the first credit reporting agency;
analyze the consumer credit report file to determine whether the consumer credit report file violates at least one rule from among a series of rules, wherein the series of rules includes at least one first tier rule that identifies first values that are not includible in the consumer credit report file and at least one second tier rule that identifies second values that are updatable in order to become includible in the consumer credit report file;
integrate credit agency validation logic, associated with the first credit reporting agency, to recognize a violation of each rule from among the series of rules;
determine, based on results of the analyzing of the consumer credit report file and the integrating of the credit agency validation logic, whether the consumer credit report file is compliant with applicable governmental regulations;
when a determination is made that the consumer credit report file is not compliant with at least one from among the applicable governmental regulations, modify the consumer credit report file such that, as modified, the consumer credit report file is fully compliant with all of the applicable governmental regulations, wherein the modifying includes integrating an artificial intelligence (AI) model and the credit agency validation logic to perform the modifying and to verify compliance with the applicable governmental regulations;
transmit, via the communication interface, the consumer credit report file to the first credit reporting agency; and
determine, based on a result of the analysis and the modification, a first score that provides a rating for the consumer credit report file.

11. The computing apparatus of claim 10, wherein the consumer credit report file is automatically modifiable so as to ensure that the consumer credit report file does not violate the at least one second tier rule.

12. The computing apparatus of claim 10, wherein the processor is further configured to:
when the consumer credit report file violates the at least one first tier rule, prompt a user to provide an input that is usable for replacing at least one invalid value that is not includible in the consumer credit report file.

13. The computing apparatus of claim 10, wherein the processor is further configured to:
receive, via the communication interface, from an electronic Online Solution for Complete and Accurate Reporting (e-OSCAR) portal, a dispute inquiry that relates to the first set of data;
create a workflow that compiles information related to the dispute inquiry;
analyze the consumer credit report file, the created workflow, and the dispute inquiry to determine an accuracy of the first set of data; and
when a determination is made that the first set of data includes at least one inaccurate data item, automatically modify the at least one inaccurate data item in order to resolve the dispute inquiry.

14. The computing apparatus of claim 13, wherein the processor is further configured to:
capture historical data related to prior dispute inquiries;
transmit the first set of data and the historical data to a machine learning model;
generate, via the machine learning model, corrections to the first set of data;
generate, based on the modification of the at least one inaccurate data item, a response to the dispute inquiry; and
transmit, via the communication interface to at least one predetermined entity, a notification of the response to the dispute inquiry.

15. The computing apparatus of claim 13, wherein the dispute inquiry comprises at least one from among a first inquiry that relates to a discrepancy in a transaction payment history and a second inquiry that relates to incorrect information included in a credit report.

16. (canceled)

17. The computing apparatus of claim 10, wherein the processor is further configured to determine the first score by:
assessing each respective field included in the consumer credit report file to determine whether the respective field is a key field;
assigning, to each respective field included in the consumer credit report file, a respective weight;
evaluating each respective field to determine a respective percentage value that indicates an adherence to a corresponding standard;
for each respective field, combining the respective weight with the respective percentage value to determine a respective field-specific score; and
calculating the first score based on a combination of the field-specific scores for all fields included in the consumer credit report file.

18. The computing apparatus of claim 17, wherein when a particular field is determined as being a key field, the respective weight for a value that corresponds to a first tier rule is equal to one from among 1.0, 1.25, 1.5, 1.75, and 2.0, and the respective weight for a value that corresponds to a second tier rule is equal to 0.75; and when the particular field is determined as not being a key field, the respective weight for the value that corresponds to the first tier rule is equal to 1.0, and the respective weight for the value that corresponds to the second tier rule is equal to 0.50.

19. A non-transitory computing readable storage medium storing instructions for generating a file that is suitable for submission to a first credit reporting agency, the storage medium comprising executable code which, when executed by a processor, cause the processor to:
receive a first set of data that relates to a consumer;
generate a consumer credit report file by using the first set of data, wherein the generating of the consumer credit report file includes automatically converting the first set of data into a predefined format that is accepted by the first credit reporting agency;
analyze the consumer credit report file to determine whether the consumer credit report file violates at least one rule from among a series of rules, wherein the series of rules includes at least one first tier rule that identifies first values that are not includible in the consumer credit report file and at least one second tier rule that identifies second values that are updatable in order to become includible in the consumer credit report file;
integrate credit agency validation logic, associated with the first credit reporting agency, to recognize a violation of each rule from among the series of rules;
determine, based on results of the analyzing of the consumer credit report file and the integrating of the credit agency validation logic, whether the consumer credit report file is compliant with applicable governmental regulations;
when a determination is made that the consumer credit report file is not compliant with at least one from among the applicable governmental regulations, modify the consumer credit report file such that, as modified, the consumer credit report file is fully compliant with all of the applicable governmental regulations, wherein the modifying includes integrating an artificial intelligence (AI) model and the credit agency validation logic to perform the modifying and to verify compliance with the applicable governmental regulations;
transmit the consumer credit report file to the first credit reporting agency; and
determine, based on a result of the analysis and the modification, a first score that provides a rating for the consumer credit report file.

20. The storage medium of claim 19, wherein the consumer credit report file is automatically modifiable so as to ensure that the consumer credit report file does not violate the at least one second tier rule.
